(19) United States
(12) Patent Application Publication
(10) Pub. No.: US 2008/0120161 A1
(43) Pub. Date: May 22, 2008

(54) HOME SELLING SYSTEM AND METHOD

(76) Inventor: Mark Jacob Saavedra, La Jolla, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/850,425

(22) Filed: Sep. 5, 2007

Related U.S. Application Data
(60) Provisional application No. 60/866,186, filed on Nov. 16, 2006.

(51) Int. Cl. G06Q 40/00; G06Q 10/00

(52) U.S. Cl. 705/8; 705/37

(57) ABSTRACT

Embodiments herein are directed to a home selling system and method. According to one embodiment, a home seller registers with the system and establishes a price for their home as well as an open house date. Agents that are located proximate to the home are notified automatically by the system. Subsequent to the open house, an offer submission process begins. During the offer submission period, agents submit offer for the home. At the end of the offer submission period, the system determines which offer is most favorable. If the seller accepts the most favorable offer, the agent who has submitted the most favorable offer is notified. Thereafter, the winning agent can become a dual agent for both the seller and the buyer and the agent then proceeds to assist the parties in closing the transaction.

### CROSS REFERENCE TO RELATED APPLICATIONS

This application claims priority to Provisional Patent Application No. 60/866,186, entitled “Home Selling System and Method,” filed on Nov. 16, 2006.

### FIELD OF THE INVENTION

The present invention relates generally to a computerized process for implementing a home sale transaction.

### BACKGROUND

Selling a home is a complicated and time-consuming transaction. A home, however, is typically a family's most important and most valuable asset. Therefore, home selling is a huge, multi-faceted, and important industry.

Traditionally a buyer and a seller are each represented by a real estate agent and the agents help facilitate the transaction for the seller and buyer and help them navigate any difficulties that occur along the way. The transaction fee, typically 6% of the sales price, is usually shared equally between the buyer's agent and the seller's agent. Splitting fees between agents, however, often presents difficult challenges. Moreover, this situation is so common that it is difficult to make a home stand out in the crowd based on the transaction fee criteria alone.

Oftentimes, sellers provide agents with exclusive listings. This method, however, requires that the agent find a ready, willing, and able buyer. If the agent does not quickly find a buyer, it can leave the seller dissatisfied. Often this method does not incentivize the agent enough because the agent is the only party that can facilitate the transaction.

Sellers also use for sale by owner (FSBO) processes to sell homes. This method requires more work by the seller as they have no selling agent acting on their behalf. This method still usually requires payment of a commission to the buyer's agent in order to have significant traffic previewing the home. Therefore, many sellers do not prefer FSBO processes because often the work involved is more cumbersome than the cost saved.

Sellers also use auctions to sell their homes. In an auction, the home is sold to the highest bidder. One problem with an auction, however, is that there needs to be sufficient ready, willing, and able buyers bidding on the home for it to reach a reasonable price. When not enough bidders show interest, the auction can be won for a price that is less than what the seller wants to sell the home for. This typically results in an unsuccessful auction or a dissatisfied seller.

Therefore, what is needed is a system and method that facilitates the home sale transaction but avoids the drawbacks described above.

### SUMMARY

Embodiments herein are directed to a home selling system and method. According to one embodiment, a home seller registers with the system and establishes a base/minimum price for their home (also called a reserve price). Agents that are located proximate to the home are notified automatically by the system. The home seller registration and the notification can take place in a computer network such as the Internet via a website. The notification can be, for example, an e-mail.

In one embodiment, the home seller uses the website to establish an open house date. The system then notifies agents who are proximate to the home location of the details of the open house. Agents who expect to bring prospective buyers to the open house can RSVP electronically via the computer network.

Subsequent to the open house, an offer submission process begins and lasts for a period of time, such as five days. During the offer submission period, agents submit offers for the home via the computer network. At the end of the offer submission period, the system determines which offer is most favorable. If the seller accepts the most favorable offer, the agent who has submitted the most favorable offer is notified. Thereafter, the winning agent becomes a dual agent for both the seller and the buyer and the agent then proceeds to assist the parties in closing the transaction and receives the entire transaction fee.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a flowchart showing one embodiment of a method for selling a home;

FIG. 2 is a block diagram showing one embodiment of a system used to implement the method of FIG. 1;

FIG. 3 is a flowchart showing a process implemented by a registration module according to an embodiment of the invention;

FIG. 4 is a flowchart showing a process implemented by a notification module according to an embodiment of the invention;

FIG. 5 is a flowchart showing a process implemented by an offer submission module according to an embodiment of the invention; and

FIG. 6 is a block diagram illustrating an example computer system that may be used in connection with various embodiments described herein.

### DETAILED DESCRIPTION

Certain embodiments as disclosed herein provide for a home selling system and method. After reading this description, it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

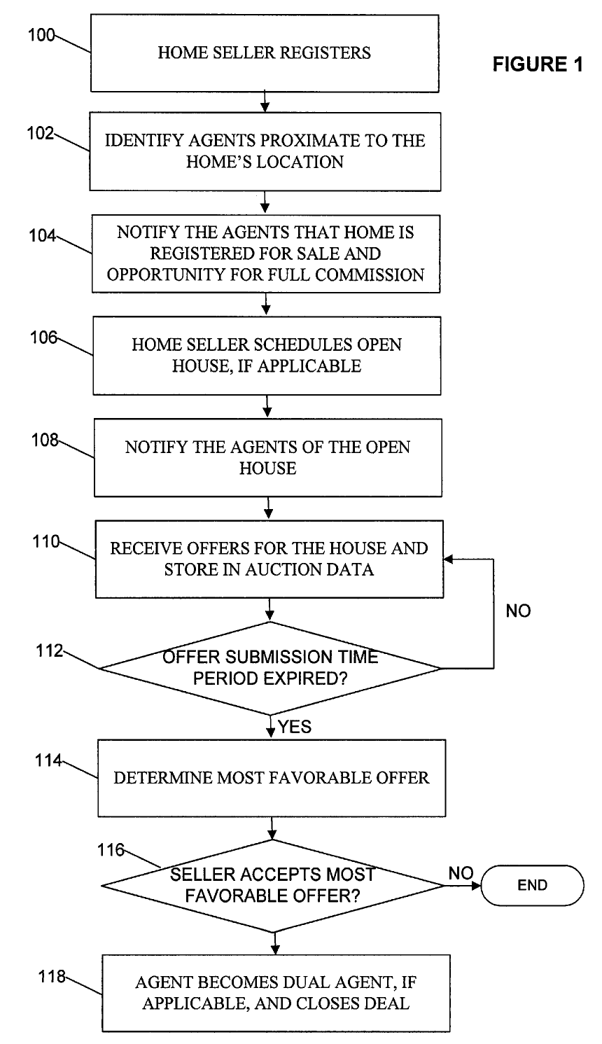

Referring now to FIG. 1, a flowchart is shown, which illustrates one embodiment of a method for selling a home. The embodiment of FIG. 1 can take place, for example, in a computer network such as the Internet. Input and output can be facilitated through a conventional website interface. At step 100, a home seller registers with the system. Registration can include, for example, establishing a log-in and a password. Registration also includes inputting data about the home for sale, the seller, and establishing a reserve price for the home. The input data is stored in a data store for later use.

At step 102, agents that are proximate to the location of the home are identified. This can include, for example, accessing the data store and determining based on rules, which agents are close enough in distance to the home to be potential agents that might facilitate an eventual sale. The county where the agent works can also be compared to the county where the home is located and matching the counties can be used to make the identification. Agents can create accounts and designate areas for which they want to receive notices.

Each agent can also have an agent area field in the data store, which indicates to the system what areas the agent is willing to work in. An opt-in flag can also be included in the data store. If the opt-in flag is true, for example, it can indicate that the agent wishes to be notified about open house dates for all areas proximate to the area the agent opted in to. In another embodiment, the data store includes information about each registered agent. The information can indicate a preference for the agent regarding which areas they wish to be notified when a home becomes available that is proximate to that area.

At step 104, the agents that are identified as being proximate to the home are notified that the home is for sale. This includes, for example, the system sending out automatic electronic communications to the agents, which can also indicate to the agents that they are capable of receiving a full commission (i.e., six percent) by utilizing the home selling system. The electronic communication can be an email, in one embodiment, and the email can include a flyer that advertises the home and shows its relevant features and characteristics. In other embodiments, the communication includes voice mails, text messages, postcards, or other communications.

At step 106, the home seller schedules an open house date. The establishing of the open house date can be performed via an interaction with the web site or server, for example. Typically the open house date is set for the next weekend after the home is listed, although this is not required. One example includes setting the open house for the next Saturday and Sunday between 10 a.m. and 4 p.m. In another embodiment, the open house scheduling is an optional step. Alternatively, the seller can skip the open house step and proceed in a traditional manner, such as placing a lock box on the home for a period of time and allowing agents with potential buyers to preview the home at their leisure.

At step 108, the agents that are identified as being proximate to the home are notified that the home has an open house date set. This includes, for example, the system sending out automatic communications to the agents. This communication can be the same communication sent in step 104 or it can be a separate communication. The same test can be used to determine which agents are proximate to the home to be invited to the open house, or a different test can be used. For example, a broader geography of agents can be notified initially (as is used in viral marketing techniques), which can give them an opportunity to respond and sign up. This can automatically cause the system to notify them that the home is for sale regardless of their proximity. The system can also receive RSVPs from the notified agent. The RSVPs can be entered into a data store and the information can be later transmitted to the seller to help them plan for the open house.

Thereafter, the open house is held where the seller opens their home and allows the agents to preview and inspect the home with their buyers. At step 110, after the open house is held, offers are received for the home and the offers are stored in the data store. The offers are typically received after the open house as a result of the buyer desiring to purchase the home. At step 112, the system determines whether the offer submission time period has expired. The offer submission time period is variable, but it can be set, for example, to five days. If the time period is not expired, the system continues to receive offers and stores them in the data store.

When the offer submission time period expires, the system determines at step 114 which offer was most favorable. The most favorable offer determination can be based on a number of factors. For example, the highest priced offer can be set to be the most favorable offer. The system can receive information from the home seller, as part of the authentication process, in order to determine which offer is most favorable. For example, the seller may wish to consider offers with no contingencies, shorter escrow periods, etc., as factors to determine which offer is best instead of merely choosing the highest priced offer.

At step 116, the system determines whether the seller has accepted the most favorable offer. If not, the offer submission process did not succeed and the process ends. If the seller does accept the most favorable offer, the agent becomes a dual agent at step 118 and facilitates the closing of the transaction by representing both the buyer's and the seller's interests. This allows the agent to receive the total transaction fee (usually six percent), since the need to split the six percent commission between two agents is avoided. This also enhances the attractiveness of the process from the agent's perspective and it gives agents incentive to bring buyers to the open house and encourage higher offers in the offer submission process.

It should be noted that the seller need not accept or reject the most favorable offer outright in step 116. Instead, a counteroffer process (not shown), which is common in the home selling process, may occur. The counteroffer process may include, for example, a counteroffer by the seller to the buyer and the buyer either accepting or rejecting the counteroffer, or the buyer submitting another counteroffer. This process can continue until the seller and the buyer reach an agreement as to the terms of the home sale and then the contract is formed by either the buyer or the seller accepting one of the counteroffers.

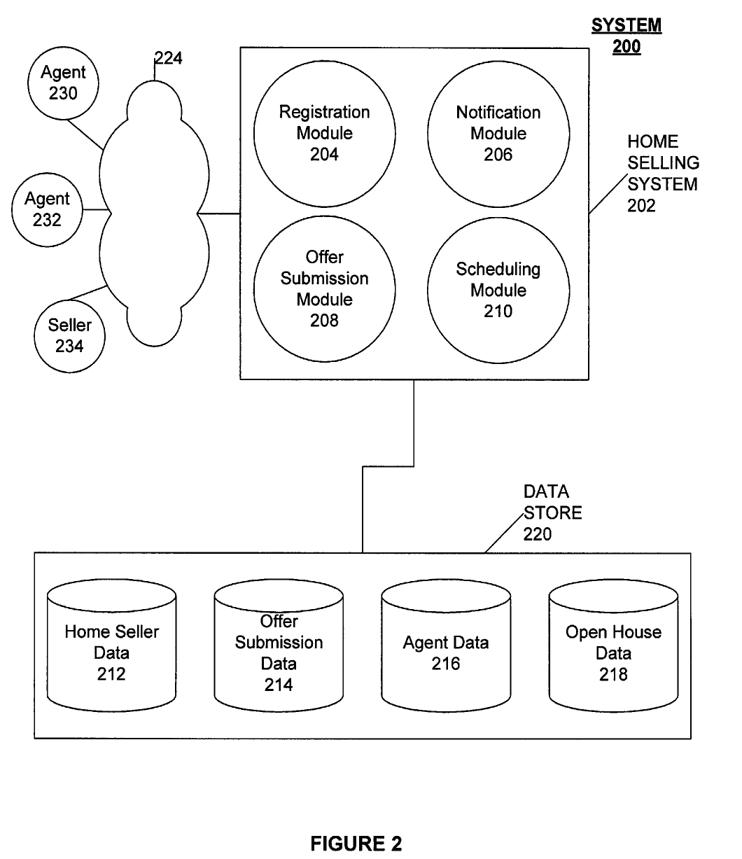

FIG. 2 is a block diagram showing one embodiment of a system used to implement the method of FIG. 1. In the illustrated embodiment, the system 200 includes a home selling system 202 and a data store 220. As shown in FIG. 2, agents 230 and 232 and a seller 234 are in communication with a wide area network 224. The wide area network 224 may be a private network, a public network, a wired network, a wireless network, or any combination of the above, including the Internet. Also in communication with the agents 230 and 232 and the seller 234 is the home selling system 202.

The agents 230 and 232 and the seller 234 can include, for example, home sellers and agents who have logged on or have a communicative coupling with the home selling system 202. There may be additional agents or additional sellers (not shown) also in communication with the home selling system 202. The home selling system 202 includes a registration module 204, a notification module 206, a scheduling module 210, and an offer submission module 208. The home selling system 202 is communicatively coupled to the data store 220. The data store 220 includes home seller data 212, offer submission data 214, agent data 216, and open house data 218. Although the elements of the home selling system 202 and the data store 220 are shown as having a plurality of separate modules, the functionality of the modules and data store elements can be implemented in different manners or as a single module and a single data store, for example.

The seller 234 logs into the home selling system 202 via the wide area network 224. The seller 234 is authenticated to the home selling system 202 by the registration module 204. Likewise, the agents 230 and 232 sign up with the home selling system 202 using the registration module 204. As the seller 234 or the agents 230 and 232 register, the data associated with them is stored in the data store 220. Data associated with the seller 234 is stored in the home seller data 212. Data associated with the agents 230 and 232 is stored in the agent data 216. Home seller data 212 includes, for example, name, address, price of the home, condition and details about the home, time frames, contact information, log in, password, etc. Agent data 216 includes, for example, name, address, agency, county, contact information, log in, preferred regions, password, etc.

Once the agents 230 and 232 and the seller 234 are registered into the home selling system 202 and the appropriate data is stored in the data store 220, the notification module 206 can produce automatic notifications in a number of ways. The notification module 206 can access the agent data 216 to notify the seller 234 when an agent RSVPs to an open house. The notification module 206 can access the home seller data 212 to notify the agents 230 and 232 when the seller 234 lists the home. The notification module 206 can also access the open house data 218 to notify the agents 230 and 232 when there is an open house in the near future.

Once the open house is completed, the offer submission module 208 handles the processes required to implement a home sale offer submission process. This includes, for example, receiving offers from agents and storing the offers in the offer submission data 214.

In one embodiment, the offer submission data 214 can be made publicly available to the agents who have registered with the home selling system 202. In this manner, an agent assisting in the submission of an offer can be aware of other offers that have been submitted as well as the party making the offer, the nature of the offer, the date and time of the offer (via a timestamp), etc. In another embodiment, the notification module 206 can notify all agents representing buyers, when a new offer comes into the home selling system that bested their offer.

Once the offer submission time period is complete (e.g., five days), the offer submission module 208 accesses the offers stored in the offer submission data 214 and analyzes them to determine which of the offers is most favorable.

For example, in one embodiment, the offer submission module 208 accesses the offer submission data 218 and the offer submission data 218 is organized as a data structure in which one of the elements associated with each offer is a price. The offer submission module 208 examines each entry and identifies the highest price. The offer associated with the highest price is then selected by the offer submission module 208 as the winning offer.

In other embodiments, other factors are considered by the offer submission module 208 and may be affected by home seller data 212 input by a home seller. For example, certain home sellers may regard actual price as a non-determinative factor and instead look for a shortest escrow or an offer not having any contingencies. In this embodiment, these factors and others can be used to determine one or multiple potential best offers for the seller to consider.

In another embodiment, the offer submission module 208 can determine a number of most favorable offers (e.g., the top 3). These most favorable offers can receive counteroffers from the seller. Alternatively, the offer submission module 208 can send the seller's counteroffer to every agent who has submitted an offer regardless of the nature of the offers.

In another embodiment, the offer submission module 208 accesses the offer submission data 218 and the offer submission data 218 is organized as a data structure in which the elements include a reserve price and an allowance price. The reserve price is the minimum value the seller is willing to accept for the home. The allowance price is the maximum value the seller is willing to contribute to repairs. For example, if the reserve price is $500,000 and the allowance price is $10,000, then the seller would be willing to sell the home for $490,000 after all repairs are made and all contingencies removed. In another embodiment, the system allows an agent to contribute a portion of their commission in order to ensure that the reserve price and the allowance price are met.

The scheduling module 210 keeps track of important dates involved in the transactions handled by the home selling system 202. For example, when a seller schedules an open house, the scheduling module 210 calendars the date. When the date becomes close (e.g., within a week or within 3 days), the scheduling module 210 instructs the notification module 206 to notify the proximate agents. Similarly, when the offer submission process begins, the scheduling module 210 calendars the ending date for the offer submission process (e.g., 5 days or 15 days). At the expiration of the offer submission period, the scheduling module 210 instructs the offer submission module 208 to begin analyzing the offers to determine the most favorable offer.

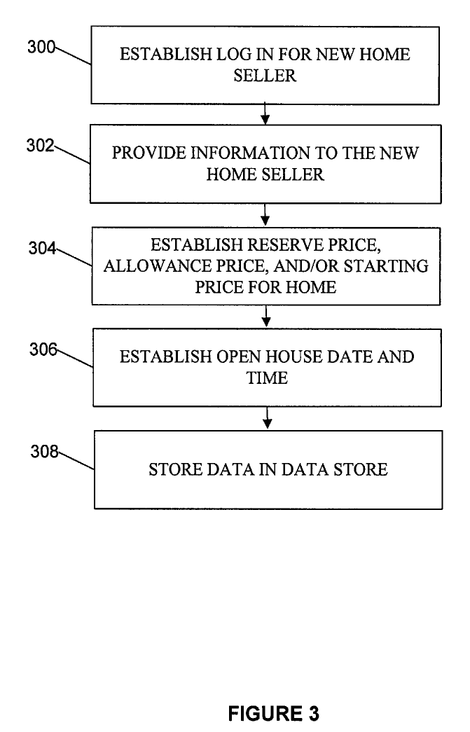

FIG. 3 is a flowchart showing a process implemented by a registration module according to an embodiment of the invention. The registration module 204 can implement the process of FIG. 3, for example, when a new home seller signs up with the home selling system 202 on a website. At step 300, the new home seller establishes a log-in.

This includes, for example, navigating a form in a web page and entering data into various data entry areas. As a result, the registration module 204 verifies that the log-in name and password are unique and whether they comply with any specific requirements imposed by the various embodiments of the home selling system 202. For example, the home selling system 202 may require the log-in be unique, have at least five characters, or it include at least one numeric character, etc. Similar requirements may be imposed for the password as well.

At step 302, the registration module provides information to the home seller. This may include, for example, accessing the home seller data 212 to retrieve standard information that sellers need to know before selling a home, such as information about the home selling process and information such as the prices of recently sold homes in the neighborhood or general proximity of the home for sale (“comps”). This can assist the seller in determining an initial price for the sale of the home.

Thereafter, at step 304, the seller establishes the reserve (or minimum) price for the home. The reserve price represents a price, below which the seller is not willing to sell the home. The seller may also establish a starting price. The starting price is typically less than the reserve price. The seller is typically not willing to sell the home for the starting price but it is used to generate initial interest in the home. The seller can also establish an allowance price at step 304, which represents the maximum dollar value for all contingencies that the seller is willing to pay for. This includes, for example, structural repairs, termite repairs, etc. At step 306, the data, including the price and information about the seller, the seller's log-in, and the seller's home is stored in the data store 220.

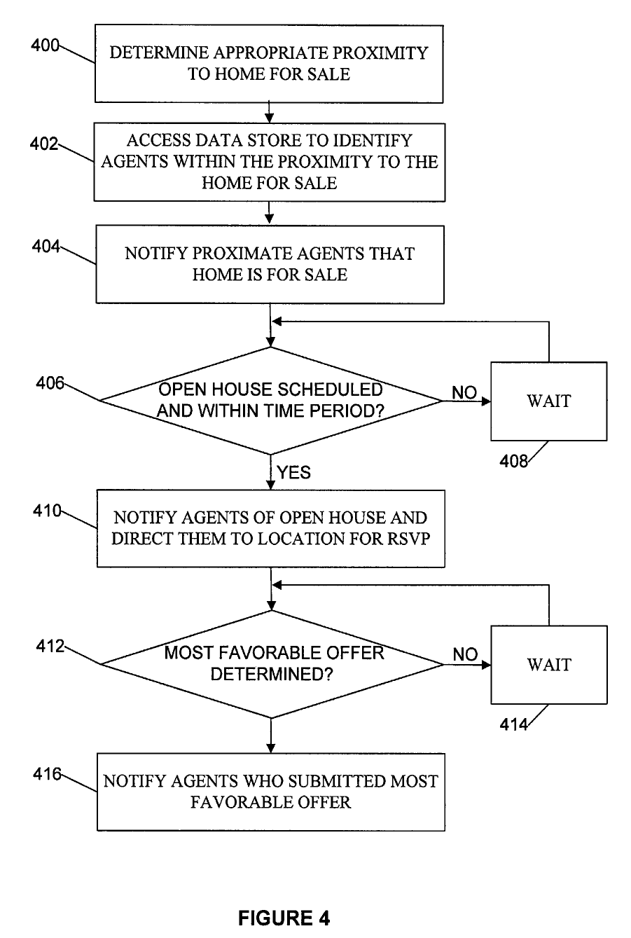

FIG. 4 is a flowchart showing a process implemented by a notification module according to an embodiment of the invention. The notification module 206 can implement the process of FIG. 4, for example, when a new home seller signs up with the home selling system 202 on a website and the new home seller has provided all of the information needed to begin the process of selling the home (including completing the registration process).

At step 400, the notification module 206 determines an appropriate proximity regarding the home for sale. This can include, for example, determining the county where the home is located and establishing the county as the appropriate proximity. Different geographic locations can treat the proximity differently in different embodiments. For example, in New York City, the county may be too broad of a measure of proximity so more narrow measures can be defined. In one embodiment, the notification module 206 establishes a radial distance from the home and treats a circle centered at the home as the proximity. Similarly, a polygon of substantially any size and shape can be defined to establish a proximity test to determine which agents fall within the proximity.

At step 402, the notification module 206 accesses the data store 220 to determine which agents are within the proximity. In one embodiment, this includes matching the county for the home with the county associated with the agent and retrieving all agents where the counties match. This can also include, for example, establishing latitude and longitude minimum and maximums for whatever shape the home selling system 202 defines and retrieving latitude and longitude values associated with the agent's locations and choosing agents whose location based coordinates fall within the minimum and maximum.

In step 404, the notification module 206 notifies the proximate agents that the seller has listed the home for sale. At step 406, the notification module 206 makes a determination as to whether the open house has been scheduled and whether it is within a time period indicating that it is within a threshold number of days. The scheduling module 210 can also be used to assist in determining the relevant dates. If the open house is determined at step 406 to be too far away (e.g., more than the threshold number of days, such as a week), the notification module 206 waits at step 408. When step 406 becomes true (i.e., the open house is within the threshold number of days), the notification module 206 notifies the agents at step 210 and directs them to the website so they can RSVP. In one embodiment, a viral marketing technique is used. In this embodiment, step 404 and others used by the notification module 206 can send the communications to every agent in the data store 220 or every agent in the county, rather than just to proximate agents.

Next, the notification module 206 waits until the offer submission process for the home is complete. The scheduling module 210 can also be used to assist in determining the relevant date when the offer submission process is complete. For example, the scheduling module 210 may calendar a date for thirty days after the offer submission process starts. When the scheduling module 210 instructs the notification module 206 that the offer submission process is not yet complete and the most favorable offer is not yet determined at step 412, the notification module 206 waits at step 414. When step 412 becomes true (i.e., the offer submission module 208 has determined the most favorable offer), the notification module 206 notifies the agent at step 416 who submitted the most favorable offer.

In other embodiments, the notification module 206 can have additional functionality. For example, the notification module 206 can notify the seller about agents that RSVP for the open house (not shown). This can allow the seller to prepare better for the open house, for example, and to better follow up afterward with agents who attended the open house.

The notification module 206 can also notify the buyer's agents who have submitted an offer, that another buyer has submitted another offer that is more favorable than their offer. In this manner, the buyer's agent can inform their buyer that their prior offer was bested and the buyer can take appropriate action. For example, if the buyer is willing to pay more for the home than they previously had offered, then the buyer can submit a new offer, which potentially is more favorable than the current best offer. The notification module 206 can also facilitate the counteroffer process.

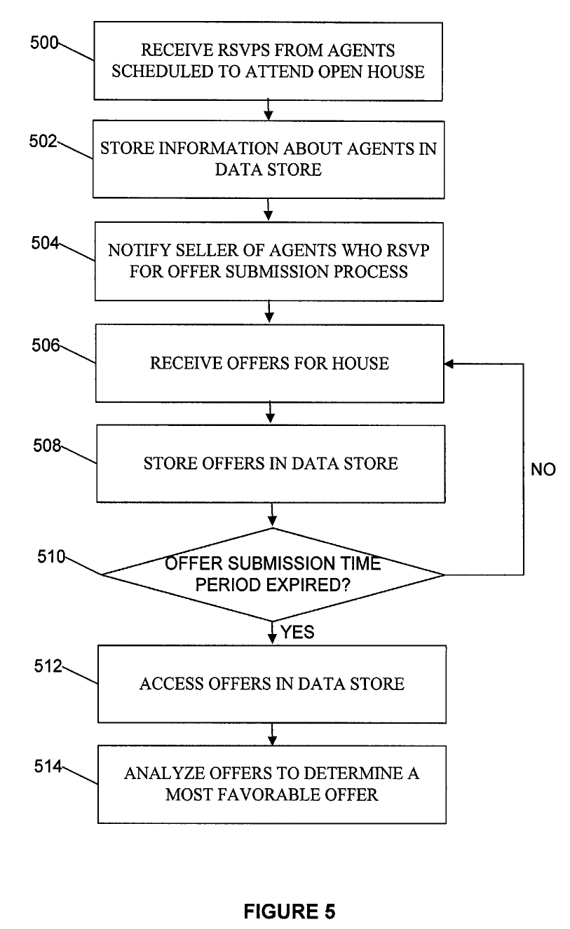

FIG. 5 is a flowchart showing a process implemented by an offer submission module according to an embodiment of the invention. The offer submission module 208 can implement the illustrated process, for example, when the open house is completed and it is time for the home seller to begin receiving offers to buy the home.

At step 500, the agents RSVP, indicating that they will be attending the open house. While step 500 is not required, it can assist the seller in preparing for the open house and it allows the data store 220 to have additional information about who will be attending the open house. At step 502, information about the agents who RSVP is stored in the data store 220.

At step 504, the notification module 206 can notify the seller about the agents who submitted an RSVP for their open house. This can allow the seller to follow up, if desired, after the open house. The seller can also collect agent information at the open house and input the information into the system for use by the offer submission module 208, in order to solicit offers. At step 506, the offer submission module 208 receives offers for the home. The offer submission module 208 can receive the offers in a number of ways. The offers can be faxed to a dedicated number where they are scanned in to the offer submission module 208. Alternatively, the agent submitting the offer can scan it in and email it to the offer submission module 208, or the agent can enter the offer information into the website, text message it to the offer submission module 208, or email it to the offer submission module 208.

Regardless of the method for submitting the offer, the offer submission module 208 stores the offers in the data store 220 at step 508. Storing the offer in the data store 220 can include, for example, scanning or otherwise transforming the offer to a digital format and then identifying the data in the offer that needs to be stored, such as the names of the buyer, the buyer's agent, the terms of the offer, the price of the offer, etc.

At step 510, the offer submission module 208 determines if the time to submit offers has elapsed. This may include the offer submission module 208 querying the scheduling module 210. The scheduling module 210 can keep track of an offer submission process expiration date and also has access to the current date. When the scheduling module 210 determines that the current date is later than the offer submission process expiration date, it notifies the offer submission module 208 that step 510 has become true.

It should be noted that in states where dual agency is prohibited, the present system can be adapted such that the agent representing the offeror becomes the buyer's agent only.

Thereafter, the offer submission module 208 accesses all offers for the current home in the data store 220 at step 512. At step 514, the offer submission module 208 analyzes the offers to determine which offer is most favorable. Thereafter, the seller and the dual agent work together, along with the buyer to finalize and close the transaction.

Finalizing and closing the transaction includes, for example, the seller agreeing to the most favorable offer. When the seller agrees to the most favorable offer, the agent becomes a dual agent who has a fiduciary relationship to both the buyer and the seller. The agent then ensures that all inspections, such as physical, termite, and other applicable inspections are performed within any relevant time periods.

If any repairs need to be made to the seller's home, the agent mediates who will pay for what repairs. Once the buyer and the seller agree on all remaining conditions of the purchase agreement, the home sale closes and the transfer of ownership takes place. Thereafter, the dual agent is able to receive the complete transaction fee (typically of six percent) since the agent represented both sides of the transaction.

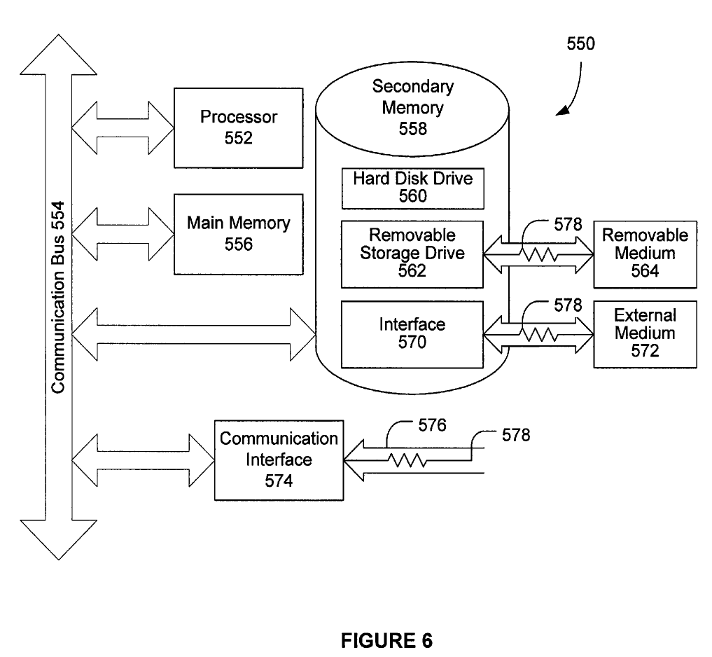

FIG. 6 is a block diagram illustrating an example computer system that may be used in connection with various embodiments described herein. For example, the computer system 550 may be used in conjunction with the home selling method described in FIG. 1 or the system 200 in FIG. 2, which implements the home selling method. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform a home selling method.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above-described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A home selling system comprising:
a registration module configured to authenticate a home seller, to establish a reserve price for a sale of a home of the home seller, and to establish an open house date;
a data store configured to receive information about the home seller, the home, and the open house date;
a scheduling module for storing the open house date and an offer submission process expiration date;
a notification module configured to notify a plurality of agents that the home is for sale, to determine whether an agent is in proximity to the home, and to notify an agent of the open house date, if the agent is in proximity to the home and a current date is within a time period from the open house date stored by the scheduling module, and to notify the agent if the agent submits a most favorable offer; and
an offer submission module configured to receive offers from a plurality of agents and to determine a most favorable offer when the offer submission process expiration date stored by the scheduling module has passed.

2. The home selling system of claim 1 wherein the registration module authenticates the home seller by receiving a log in, a password, and data associated with the home seller.

3. The home selling system of claim 1 wherein the registration module provides additional information to the home seller about a home sale process.

4. The home selling system of claim 1 wherein the notification module determines whether the agent is in proximity to the home by determining a county for the home and determining a county for the agent by searching the data store and matching the county for the home with the county for the agent.

5. The home selling system of claim 1 wherein the notification module notifies the agent that the home is for sale and of the open house date by sending an electronic communication.

6. The home selling system of claim 5 wherein the electronic communication is sent to an address stored in the data store.

7. The home selling system of claim 1 wherein the offer submission module determines the most favorable offer by determining a highest priced offer.

8. The home selling system of claim 1 wherein the offer submission module determines the most favorable offer by identifying an offer with a lowest number of contingencies.

9. The home selling system of claim 1 wherein the registration module receives an RSVP from the agent in response to the notification module notifying the agent of the open house date.

10. The home selling system of claim 1 wherein the notification module notifies the agent that submits the most favorable offer via electronic communication.

11. The home selling system of claim 1 wherein the notification module determines whether the agent is in proximity to the home by analyzing an agent area field and an opt-in flag.

12. The home selling system of claim 1 wherein the offer submission module determines the most favorable offer by determining a highest priced offer, determining a reserve price, and determining whether the highest priced offer exceeds the reserve price.

13. A method of selling a home, the method comprising:
authenticating a home seller;
establishing a reserve price for a sale of a home of the home seller;
establishing an open house date;
storing the open house date and an offer submission process expiration date;
identifying a plurality of agents in proximity to the home;
notifying each agent that is proximate to the home that the home is for sale;
notifying each agent that is proximate to the home of the open house date within a pre-determined time period before the open house date;
receiving a plurality of home purchase offers from a plurality of agents;
analyzing the plurality of home purchase offers to determine the most favorable offer when the offer submission process expiration date has passed;
notifying the agent who submitted the most favorable offer; and
facilitating a purchase of the home with the submitting agent as an agent for the seller and an agent for the buyer.

14. The method of claim 13 wherein authenticating the home seller further comprises receiving a log in, a password, and data associated with the home seller.

15. The method of claim 13 further comprising providing additional information to the home seller about a home sale process.

16. The method of claim 13 wherein the step of identifying further comprises:
determining a county for the home;
determining a county for the agent; and
matching the county for the home with the county for the agent.

17. The method of claim 13 wherein notifying each agent that is proximate to the home that the home is for sale and notifying each agent that is proximate to the home of the open house further comprises sending an electronic communication.

18. The method of claim 17 wherein the electronic communication is sent to an address stored in a data store.

19. The method of claim 13 wherein the step of analyzing further comprises determining a highest priced offer.

20. The method of claim 13 wherein the step of analyzing further comprises identifying an offer with a lowest number of contingencies.

21. The method of claim 13 further comprising receiving an RSVP from an agent in response to notifying each agent that is proximate to the home of the open house date.

22. The method of claim 13 wherein notifying the agent who submitted the most favorable offer further comprises sending an electronic communication.

23. The method of claim 13 wherein the step of analyzing further comprises:
determining a highest priced offer;
determining a reserve price; and
determining whether the highest priced offer exceeds the reserve price.

24. The method of claim 13 wherein the step of identifying further comprises:
identifying information about an agent;
identifying an area of the home; and
determining whether the information about the agent indicates a preference to be notified about the home in the area.
